(19) United States
(12) Patent Application Publication
(10) Pub. No.: US 2012/0048921 A1
(43) Pub. Date: Mar. 1, 2012

(54) CODE READING APPARATUS AND SALES REGISTRATION APPARATUS

(75) Inventor: Toshinari Shimizu, Shizuoka (JP)

(73) Assignee: TOSHIBA TEC KABUSHIKI KAISHA, Tokyo (JP)

(21) Appl. No.: 13/219,854

(22) Filed: Aug. 29, 2011

(30) Foreign Application Priority Data
Sep. 1, 2010 (JP) 2010-196200

(51) Int. Cl. G06F 17/30

(52) U.S. Cl. 235/375

(57) ABSTRACT

An embodiment is a code reading apparatus that includes an image acquiring unit, a code reading unit, an output unit, a setting unit, and a recording unit. The image acquiring unit acquires an image that an image capturing unit captures. The code reading unit detects a code symbol that is attached to a commodity which is contained in the acquired image and reads code information that corresponds to the code symbol. The output unit outputs the read code information. The setting unit performs setting of a operator. The recording unit records the acquired image by associating the image with operator information that indicates the set operator.

### CROSS-REFERENCE TO RELATED APPLICATION

This application is based upon and claims the benefit of priority from Japanese patent application number 2010-196200, filed on Sep. 1, 2010, the entire contents of which are incorporated herein by reference.

### FIELD

Embodiments described herein relate generally to a code reading apparatus and a sales registration apparatus.

### BACKGROUND

Conventionally, in stores such as supermarkets, a commodity code reading apparatus that image captures a code symbol such as a barcode or a two-dimensional code (for example, a QR code (registered trademark)) that is attached to a commodity by a digital camera such as a CCD image sensor and which reads a commodity code by detecting and decoding a code symbol from the captured image is used. A operator registers a commodity that a customer purchases by taking out a commodity that is kept in a shopping basket that the customer brings over to a counter and holding the commodity over a digital camera of a commodity code reading apparatus.

### DESCRIPTION OF THE DRAWINGS

FIG. 1 illustrates a perspective diagram of a checkout system.

FIG. 2 illustrates a block diagram of a hardware configuration of a POS terminal and a code reading apparatus.

FIG. 3 exemplifies a conceptual diagram of a data configuration of a captured image data management file.

FIG. 4 illustrates a block diagram of a functional configuration of a CPU.

FIG. 5 illustrates a flowchart of one example of the actions of a checkout system.

FIG. 6 schematically illustrates a conceptual diagram of the state between the setting of a operator and the end of the procedure by the operator.

### DETAILED DESCRIPTION

An embodiment is a code reading apparatus that includes an image acquiring unit, a code reading unit, an output unit, a setting unit, and a recording unit. The image acquiring unit acquires an image that an image capturing unit captures. The code reading unit detects a code symbol that is attached to a commodity which is contained in the acquired image and reads code information that corresponds to the code symbol. The output unit outputs the read code information. The setting unit performs setting of a operator. The recording unit records the acquired image by associating the image with the operator information.

In addition, another embodiment is a sales registration apparatus that includes the code reading unit, the setting unit, a sales registration unit, and the recording unit. The code reading unit detects a code symbol that is attached to a commodity which is contained in the acquired image and reads code information that corresponds to the code symbol. The setting unit performs setting of a operator that registers the sales of a commodity. The sales registration unit registers the sales of a commodity based on the read code information. The recording unit records the captured image by associating the image with the operator information.

Below, a code reading apparatus and a sales registration apparatus according to the present embodiment will be described with reference to the drawings with a checkout system as an example. The checkout system has a configuration of including a POS terminal as a sales registration apparatus that performs registration and clearing of commodities relating to one transaction and a code reading apparatus that reads a commodity code or the like which is attached to a commodity, and is one example of a store system. The embodiment is an applied example of the checkout system that is installed in a store such as a restaurant or a supermarket.

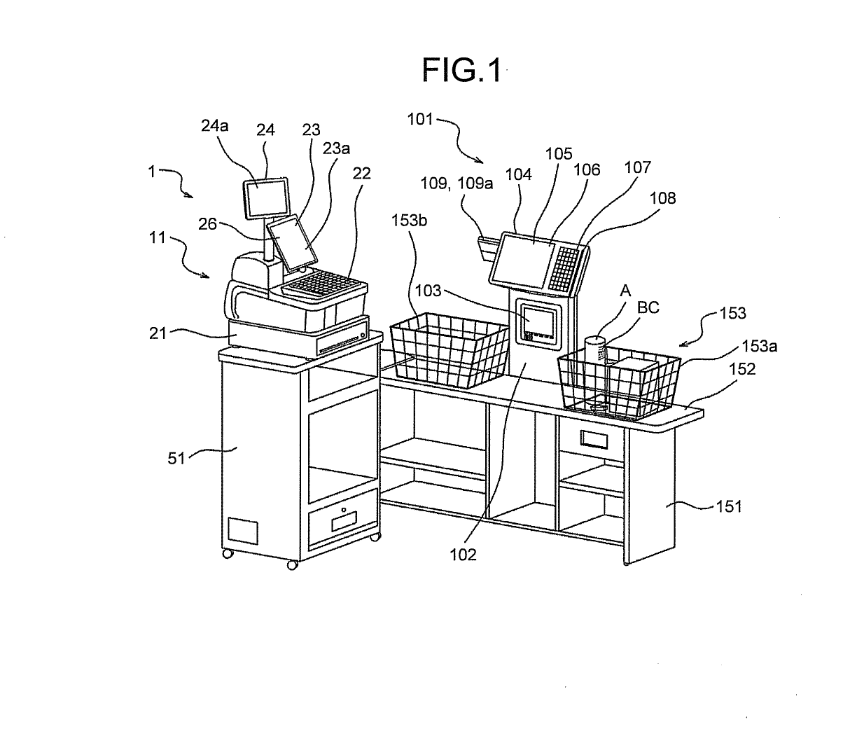

FIG. 1 illustrates a perspective diagram of a checkout system 1. As illustrated in FIG. 1, the checkout system 1 includes a POS terminal 11 that performs registration and clearing of a commodity for a single transaction. The POS terminal 11 is placed on an upper surface of a drawer 21 over a checkout stand 51. A keyboard 22 that is operated by being pressed down by an operator (store clerk) is arranged on an upper surface of the POS terminal 11. A display device 23 that displays information to the store clerk is provided further back from the keyboard 22 as seen by the store clerk that operates the keyboard 22. The display device 23 displays information on a display surface 23a thereof. A touch panel 26 is laminated on the display surface 23a. A customer display device 24 is provided upright to be rotatable further back from the display device 23. The customer display device 24 displays information on a display surface 24a thereof.

An oblong counter stand 151 is arranged so as to form an L shape with the checkout stand 51 on which the POS terminal 11 is placed. A load-bearing surface 152 is formed on an upper surface of the counter stand 151. A shopping basket 153 that holds commodities A on which barcodes BC are attached is placed on the load-bearing surface 152. The shopping basket 153 can be thought of separately as a first shopping basket 153a that is brought by the customer and a second shopping basket 153b that is positioned at a position that interposes a code reading apparatus 101 with the first shopping basket 153a.

The code reading apparatus 101 that is connected to the POS terminal 11 to be able to freely transmit and receive data is installed on the load-bearing surface 152 of the counter stand 151. The code reading apparatus 101 includes a flat rectangular housing 102. A reading window 103 is arranged on the front surface of the housing 102. A displaying and operating unit 104 is affixed to an upper portion of the housing 102. A display device 106 on the front surface of which a touch panel 105 is laminated is provided on the displaying and operating unit 104. A keyboard 107 is arranged next to the display device 106 on the right. A card reading slit 108 that is a card reader (not shown) is provided next to the keyboard 107 to the right. A customer display device 109 that is a display device provided to face the customer for displaying information to the customer is installed to the back left side of a back surface of the displaying and operating unit 104 as seen by the store clerk. A customer touch panel 109a is laminated on a display surface of the customer display device 109.

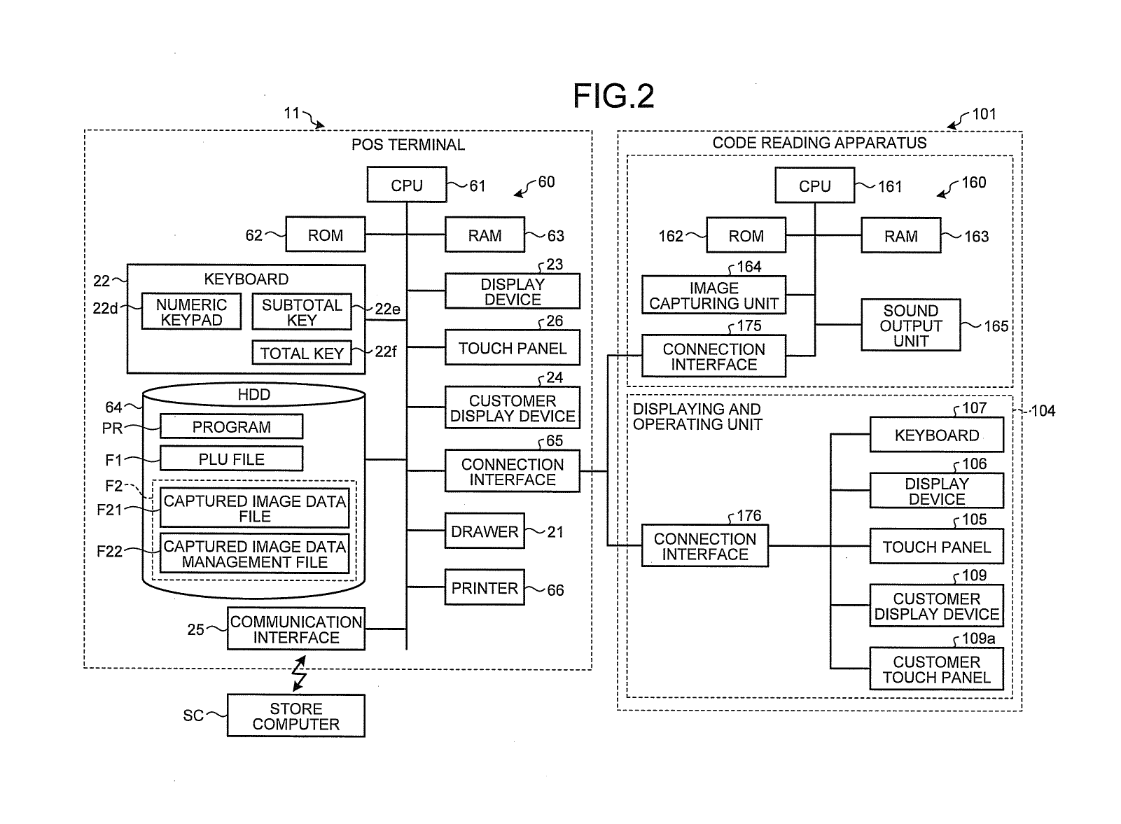

The first shopping basket 153a that is brought by the customer contains the commodities A for one transaction. The barcodes BC in which commodity codes (code information) relating to the commodities A are encoded are attached to the commodities A. The commodities A are moved to the second shopping basket 153b by a hand of the store clerk. The barcode BC is pointed to the reading window 103 of the code reading apparatus 101 by such a movement process. At this time, an image capturing unit 164 (refer to FIG. 2) that is arranged to the back side of the reading window 103 image captures the barcode BC. In the code reading apparatus 101, the commodity codes that correspond to the commodities A are read by detecting and decoding the barcodes BC that are attached to the commodities A and are contained in the images captured by the image capturing unit 164. Next, the code reading apparatus 101 outputs the read commodity codes to the POS terminal 11.

The commodity codes that are described above as the barcodes BC are codes that are assigned to each commodity to specify the commodities A, and as an example, are JAN codes with 13 numerical digits. Here, although the barcode BC will be described as an example as the code symbol in the embodiment, needless to say, the code symbol may be a two-dimensional code such as a QR code (registered trademark).

FIG. 2 illustrates a block diagram of a hardware configuration of the POS terminal 11 and the code reading apparatus 101. The POS terminal 11 is provided with a microcomputer 60 as an information processing unit that executes information processing. The microcomputer 60 is configured by a ROM 62 (Read Only Memory) and a RAM 63 (Random Access Memory) connected by a bus to a CPU 61 (Central Processing Unit) that executes various types of calculation processes and controls each unit.

The drawer 21, the keyboard 22, the display device 23, the touch panel 26, and the customer display device 24 described above are all connected via various types of input and output circuits (none of which are shown) to the CPU 61 of the POS terminal 11. Such parts receive control from the CPU 61.

The keyboard 22 includes a numeric keypad 22d in which numbers such as “1”, “2”, “3” . . . and an operator for multiplying that is “x” are displayed on an upper surface, a subtotal key 22e, and a total key 22f. The keyboard 22 outputs operation inputs of the store clerk by the numeric keypad 22d, the subtotal key 22e, and the total key 22f to the CPU 61. The keyboard 22 is an operating unit configured to receive an operation from the store clerk. The POS terminal 11 performs various types of settings by receiving the operation from the store clerk through the keyboard 22. For example, the POS terminal 11 receives an input of a cashier ID, which is store clerk information identifying the store clerk such as an alphanumeric number allotted uniquely to each store clerk, and sets the store clerk who performs the operation of sales registration for the commodities A.

An HDD 64 (Hard Disk Drive) 64 is connected to the CPU 61 of the POS terminal 11. Programs and various types of files are stored on the HDD 64. The programs and various types of files that are stored on the HDD 64 have the entirety or a portion thereof copied by the RAM 63 when the POS terminal 11 is started and are sequentially executed by the CPU 61. A program PR for commodity marketing data processing is one example of a program that is stored on the HDD 64. A PLU file F1 and a shared database F2 that are transmitted from a store computer SC and stored in advance are examples of files that are stored on the HDD 64.

The PLU file F1 is a file that stores commodity codes that are uniquely assigned to each commodity and information relating to commodities such as the name relating to the commodity code, the unit price, and the commodity category. With the POS terminal 11, it is possible to register the sales of the commodities that correspond to the read commodity codes by referencing information that is stored in the PLU file F1 as the commodity codes read by the code reading apparatus 101.

The shared database F2 is a database that manages image data that is captured by the image capturing unit 164 of the code reading apparatus 101 when performing the sales registrations of the commodities A by associating the image data with the cashier ID that is set as the store clerk that performs the operation of the sales registration. The shared database F2 is shared not only by the POS terminal 11 but by the entire store by being transmitted to the store computer SC by a communication interface 25 under the control of the CPU 61.

Specifically, the shared database F2 is configured by a captured image data file F21 of moving images and still images that are captured by the image capturing unit 164, a captured image data management file F22 that manages the correspondence of the captured image data file F21 with the cashier ID, and the like. The captured image data file F21 may have moving image files in an MPEG (Moving Picture Experts Group) format or still image files in a JPEG (Joint Photographic Experts Group) format.

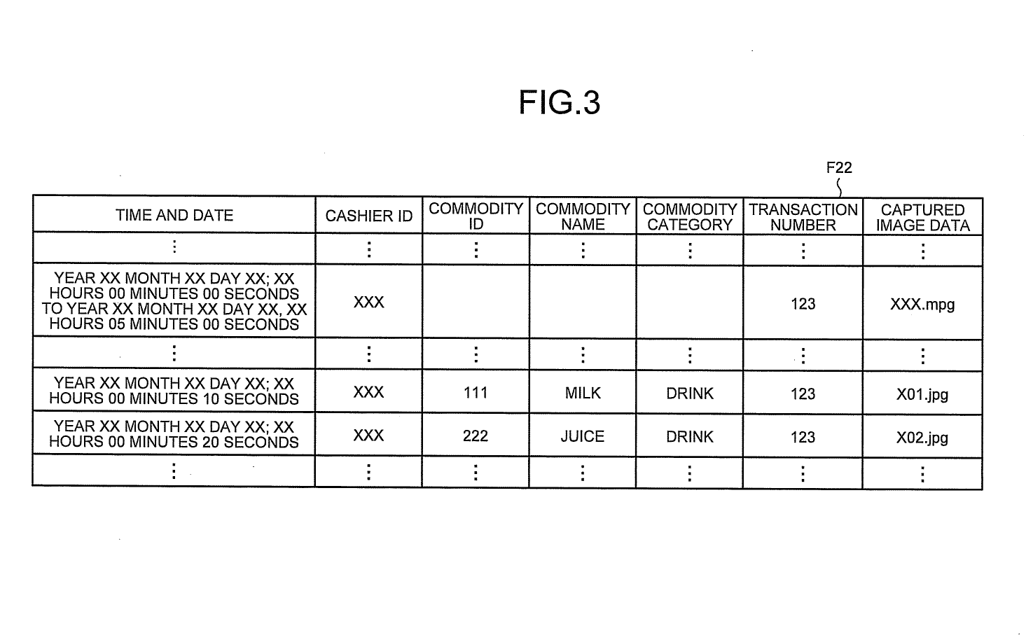

FIG. 3 exemplifies a conceptual diagram of a data configuration of the captured image management file F22. As illustrated in FIG. 3, the captured image data management file F22 includes data items such as “time and date”, “cashier ID”, “commodity code”, “commodity name”, “commodity category”, “transaction number”, and “captured image data”. Here, “time and date” stores the time and date of the image capture. “Cashier ID” stores the cashier ID that is set as the store clerk that performs the operation of sales registration. “Commodity code” stores the commodity code that is read from the captured image. “Commodity name” stores the commodity name that corresponds to the commodity code that is read from the captured image. “Commodity category” stores the commodity category that corresponds to the commodity code that is read from the captured image. “Transaction number” stores the transaction number that is assigned and applied to a single transaction of the sales registration. “Captured image data” stores the file name of the captured data file F21 and the like.

By referencing the captured image data management file F22, it can be seen that moving images of when a store clerk with the cashier ID of “XXX” performs an operation of sales registration during a transaction of a transaction number “123” between year XX month XX day XX; xx hours 00 minutes 00 seconds to year XX month XX day XX; xx hours 05 minutes 00 seconds are stored in the captured image data file F21 with the file name “XXX.mpg”. Furthermore, it can be seen that a still image relating to the sales registration of a commodity with the commodity code “111”, the commodity name “milk”, and the commodity category “drink” in the transaction is stored with the time and date of the reading as year XX month XX day XX; xx hours 00 minutes 10 seconds and stored in the captured image data file F21 with the file name “X01.jpg”.

The communication interface 25 for executing data communication with the store computer SC is connected to the CPU 61 of the POS terminal 11 via a not-shown input and output circuit. The store computer SC is installed in the backyard or the like of a store. The PLU file F1 that is transmitted to the POS terminal 11 and the shared database F2 that is transmitted from the POS terminal 11 are stored in an HDD (not shown) of the store computer SC.

A connection interface 65 that makes data transceiving with the code reading apparatus 101 possible is connected to the CPU 61 of the POS terminal 11. Therefore, the connection interface 65 is connected to the code reading apparatus 101. Further, a printer 66 that performs printing on a receipt or the like is connected to the CPU 61 of the POS terminal 11. The POS terminal 11 prints the transaction content (cleared amount or points awarded) or the like of one transaction on a receipt under the control of the CPU 61.

The code reading apparatus 101 also includes a microcomputer 160. The microcomputer 160 is configured by a ROM 162 and a RAM 163 being connected by a bus to a CPU 161. A program that is executed by the CPU 161 is stored in the ROM 162. The image capturing unit 164 and a sound output unit 165 are connected to the CPU 161 via various types of input and output circuits (none of which are shown). Actions of the image capturing unit 164 and the sound output unit 165 are controlled by the CPU 161. The displaying and operating unit 104 is connected to the POS terminal 11 via a connection interface 176. Actions of the displaying and operating unit 104 are controlled by the CPU 61 of the POS terminal 11.

The image capturing unit 164 is a CCD image sensor, a CMOS image sensor, or the like, and performs image capturing from the reading window 103 under the control of the CPU 161. For example, in the image capturing unit 164, image capturing of moving images at 30 fps is performed. Frame images that, are sequentially captured at a predetermined frame rate by the image capturing unit 164 are saved in the RAM 163. The sound output unit 165 is a sound circuit, a speaker, or the like that generates a warning sound or the like that is set in advance. The sound output unit 165 alerts of sounds such as a warning sound under the control of the CPU 161.

Furthermore, a connection interface 175 that is connected to the connection interface 65 of the POS terminal 11 and that makes data transceiving with the POS terminal 11 possible is connected to the CPU 161. Under the control of the CPU 161, a commodity code read from an image that is captured by the image capturing unit 164 of the code reading apparatus 101 is output via the connection interface 175 and input to the POS terminal 11 via the connection interface 65.

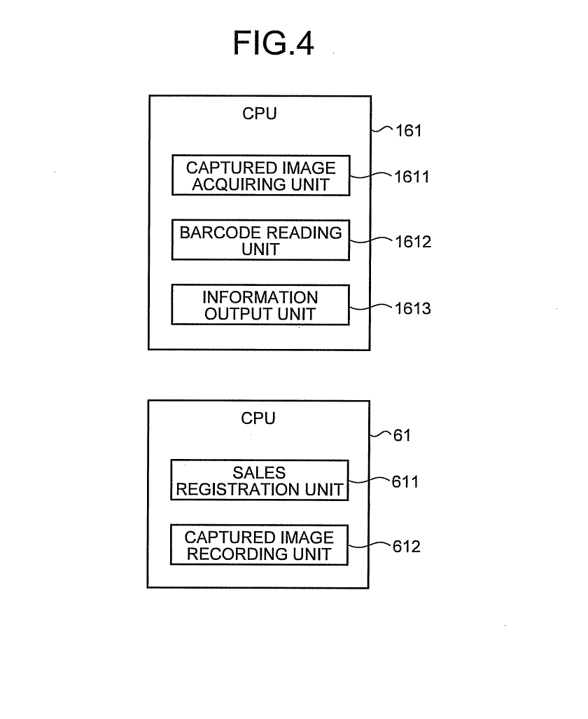

Next, the functional units of the CPU 161 and the CPU 61 that are realized by the CPU 161 and the CPU 61 sequentially executing programs will be described with reference to FIG. 4. FIG. 4 illustrates a block diagram of the functional configurations of the CPU 161 and the CPU 61. As illustrated in FIG. 4, the CPU 161 includes functions as a captured image acquiring unit 1611, a barcode reading unit 1612, and an information output unit 1613 by sequentially executing programs. Similarly, the CPU 61 includes functions as a sales registration unit 611 and a captured image recording unit 612.

The captured image acquiring unit 1611 causes the image capturing unit 164 to start an image capturing action by outputting an image capturing ON signal to the image capturing unit 164. The captured image acquiring unit 1611 sequentially acquires frame images that the image capturing unit 164 captures after starting the image capturing action and which are saved in the RAM 163. The acquisition of the frame images by the captured image acquiring unit 1611 is performed in the order that the frame images are saved in the RAM 163.

The barcode reading unit 1612 detects the code symbol that is contained in a frame image that is acquired by the captured image acquiring unit 1611 and reads code information such as the commodity code that corresponds to the code symbol. Specifically, detection of the barcode by a pattern matching technique from a binarized image of the acquired frame image, detection of a two-dimensional code from a predetermined finder pattern, and the like are performed. Next, the barcode reading unit 1612 reads the code information that corresponds to the detected barcode by converting the detected barcode or two-dimensional code into code information that follows predetermined conventions (for example, a JAN code).

The information output unit 1613 outputs the code information that the barcode reading unit 1612 reads or the images that the image capturing unit 164 captures to the POS terminal 11 via the connection interface 175.

The sales registration unit 611 identifies the commodities A that are read by the barcode reading unit 1612 by referencing the PLU file F1 based on the code information (commodity code) that is output by the code reading apparatus 101 and registers the sales of the identified commodities A. The sales registration unit 611 assigns a unique transaction number to each transaction and applies the transaction numbers when registering sales of the commodities A. The registration of sales by the sales registration unit 611 is performed by recording information such as the commodity code, the quantity, the time and date, and the transaction number on a sales master file (not shown) or the like.

The captured image recording unit 612 associates an image that is captured by the image capturing unit 164 and which is output from the POS terminal 11 with the cashier ID that is set as the store clerk that performs sales registration and records the image in the shared database F2. Specifically, while the image data that is output by the POS terminal 11 is recorded in the captured image data file F21 with a predetermined file name, the correspondence of the cashier ID that is set and the file name is recorded in the captured image data management file F22 along with the transaction number that is assigned to the transaction of the sales registration and the time and date.

Further, the captured image recording unit 612 records, when frame images that relate to reading of the commodity code are output along with a commodity code from the code reading apparatus 101, a frame image that is associated with the commodity code and which is output in the shared database F2. Specifically, while a frame image that is output from the POS terminal 11 is recorded in the captured image data file F21 with a predetermined file name, the correspondence of the file name with the set cashier ID is recorded in the captured image data management file F22 along with the commodity code, the commodity name or the commodity category that relates to the commodity code, the transaction number that is assigned to the transaction of the sales registration, and the time and date.

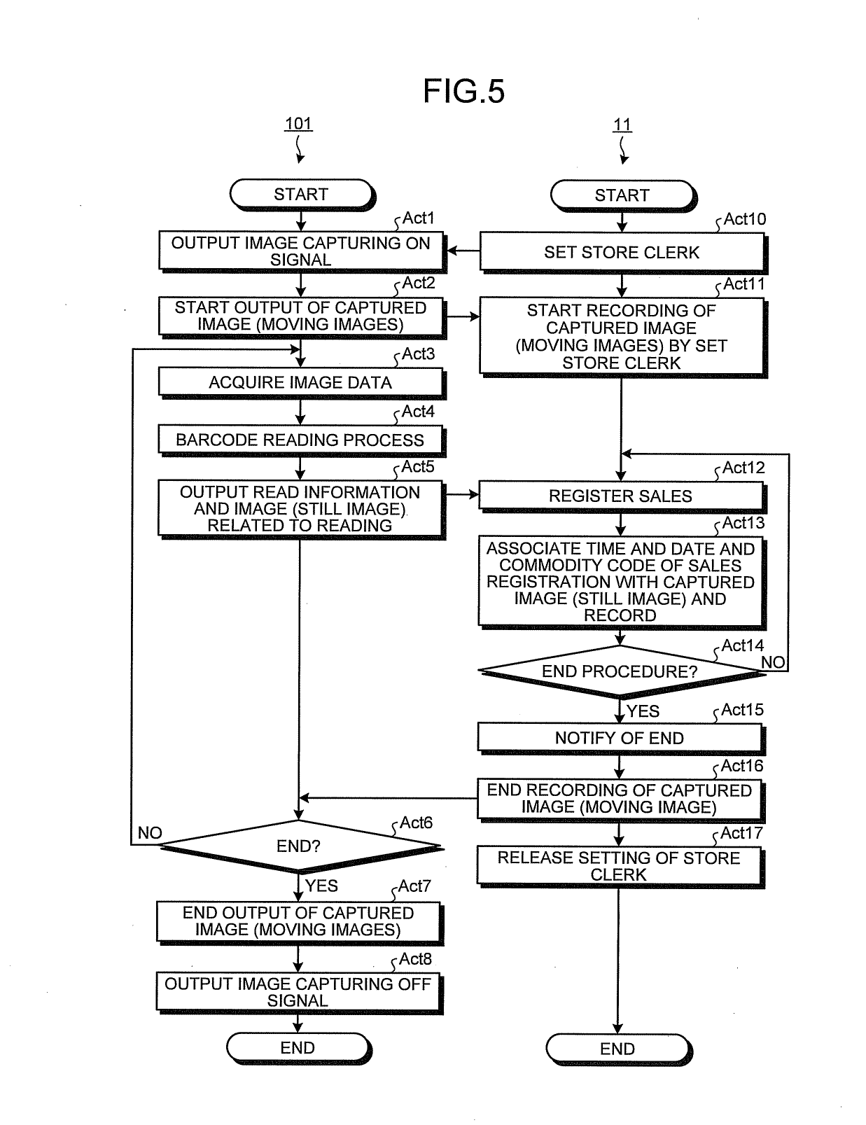

Next, actions of the checkout system 1 will be described in detail. FIG. 5 illustrates a flowchart of one example of the actions of the checkout system 1.

First, actions of the code reading apparatus 101 side will be described. As illustrated in FIG. 5, when the process is started in response to the start of commodity registration by the POS terminal 11 following the setting of the store clerk (Act 10) and the like, the captured image acquiring unit 1611 outputs an image capturing ON signal to the image capturing unit 164 and starts the image capturing by the image capturing unit 164 (Act 1). The information output unit 1613 starts the output of an image (moving image) that is captured by the image capturing unit 164 to the POS terminal 11 (Act 2). Specifically, the information output unit 1613 sequentially outputs frame images that are captured by the image capturing unit 164 to the POS terminal 11.

The captured image acquiring unit 1611 acquires frame images (captured image) that are captured by the image capturing unit 164 and which are saved in the RAM 163 (Act 3). The barcode reading unit 1612 detects a barcode that is contained in a frame image that is acquired by the captured image acquiring unit 1611 and reads a commodity code that is associated with the barcode (Act 4).

The information output unit 1613 outputs the read information such as the commodity code that is read by the barcode reading unit 1612 and frame images relating to reading of the commodity code to the POS terminal 11 via the connection interface 175 (Act 5).

The CPU 161 determines whether the procedure by the controlling store clerk is ended by a notification of the end or the like from the POS terminal 11 (Act 6). When the procedure is to be continued (Act 6: NO), the CPU 161 returns the process to Act 3 and continues the process. In such a case, since the procedure by the controlling store clerk is continued, the output of images (moving images) that are captured by the image capturing unit 164 to the POS terminal 11 is continued. When the procedure is to be ended (Act 6: YES), the information output unit 1613 ends the output of images (moving images) that are captured by the image capturing unit 164 to the POS terminal 11 (Act 7). Next, the captured image acquiring unit 1611 ends the process by outputting an image capturing OFF signal to the image capturing unit 164 and ending the image capturing by the image capturing unit 164 (Act 8).

Next, actions of the POS terminal 11 side will be described. As illustrated in FIG. 5, once the process is started, the CPU 61 sets the store clerk that performs operations such as the sales registration of the commodities A by receiving an input of the cashier ID from the keyboard (Act 10). The captured image recording unit 612 starts recording of moving image data to the shared database F2 by associating the moving image data with the cashier ID that is set in Act 10 (Act 11). At this time, the start time and date and the transaction number are stored in the image capturing data management file F22.

Next, the sales registration unit 611 registers the sales of the commodities A based on the read information (commodity codes) output from the POS terminal 11 (Act 12). The captured image recording unit 612 associates frame images relating to the reading of a commodity code which are output from the POS terminal along with the commodity code with the cashier ID that is set in Act 10 and records the time and date of the sales registration together with the commodity code in the shared database F2 (Act 13).

The CPU 61 determines whether the procedure by the controlling store clerk is ended by an operating instruction from the keyboard 22 or the like (Act 14). When the procedure is to be continued (Act 14: NO), the CPU 61 returns the process to Act 12 and continues the process. In such a case, since the procedure by the controlling store clerk is continued, the recording of moving image data to the shared database F2 is continued.

When the procedure is to be ended (Act 14: YES), the CPU 61 notifies the POS terminal 11 of the end (Act 15). The captured image recording unit 612 ends the recording of moving images in the shared database F2 (Act 16). At this time, the end time and date is stored in “time and date” of the captured image data management file F22. Therefore, in the POS terminal 11, from the controlling store clerk is set until the store clerk ends the procedure, that is, while the store clerk is set, the moving images that are captured by the image capturing unit 164 are associated with the cashier ID that indicates the store clerk and is recorded in the shared database F2. Next, the CPU 61 releases the setting of the store clerk of Act 10 and ends the process (Act 17).

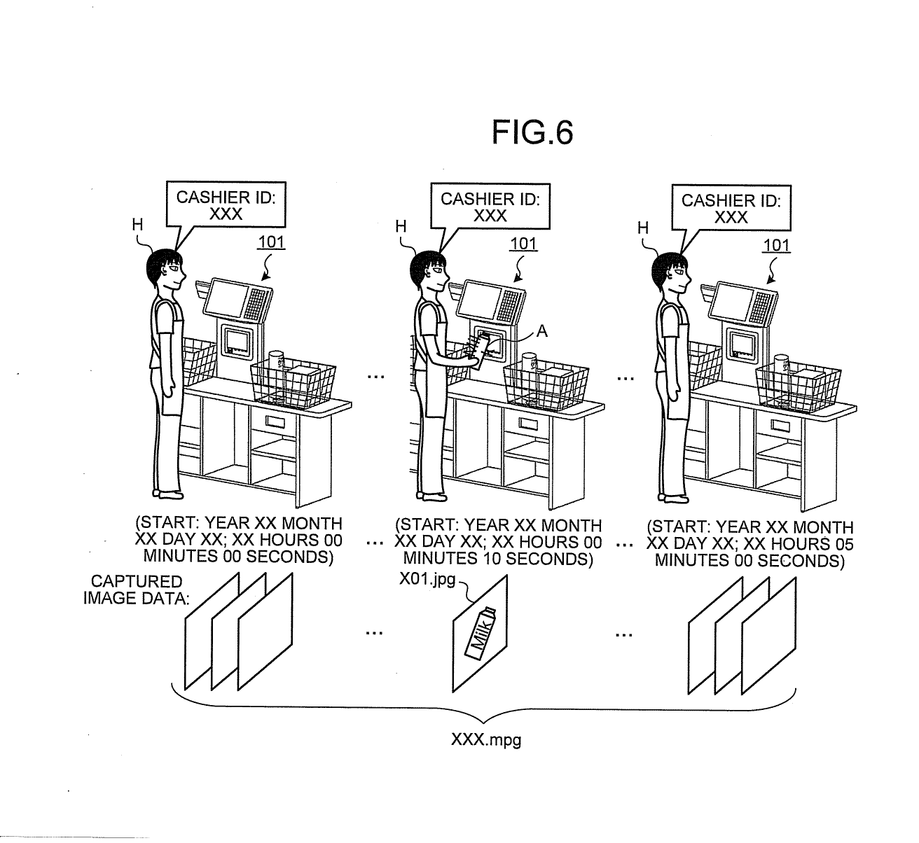

FIG. 6 schematically illustrates a conceptual diagram of the state between the setting of a store clerk H and the end of the procedure by the store clerk H. As illustrated in FIG. 6, in the embodiment, moving images that are used for reading by the code reading apparatus 101 are recorded as “XXX.mpg” in the captured image data file F21 between the setting of the store clerk with the cashier ID “XXX” until the end of the procedure, and the correspondence of the moving images with the cashier ID “XXX” is recorded in the captured image data management file F22 (refer to FIG. 3). In such a manner, by associating and recording the moving images that are captured by the code reading apparatus 101 while the store clerk is set with the cashier ID of the store clerk, the moving images are able to be used for the training of techniques relating to the reading of a commodity such as comparing moving images that are recorded for each store clerk, or the like.

In addition, in the embodiment, a read image of a commodity A that is read by a store clerk with the cashier ID “XXX” at year XX month XX day XX; XX hours 00 minutes 10 seconds is recorded as “X01.jpg” in the captured image data file F21, and the correspondence of the image with the commodity code of the commodity A is recorded in the captured image data management file F22 (refer to FIG. 3). In such a manner, by associating and recording the read images of the commodities A with the commodity codes of the commodities A, the images are able to be used for the training of techniques relating to the reading of specific commodities A, or the like. Further, since the transaction number that is assigned to each transaction is included in what is recorded in the captured image data management file F22, searching of read images by the transaction numbers thereof is able to be performed.

Here, in the embodiment, although a still image for a single frame is exemplified as a read image of a commodity A, moving images for several frames before and after “X01.jpg” may be recorded in the captured image data file F21. In such a case, it is also possible to verify the process leading up to the reading of the commodity A.

A program that is executed by the POS terminal 11 and the code reading apparatus 101 in the embodiment is provided by being built into a ROM or the like in advance. A program that is executed by the POS terminal 11 and the code reading apparatus 101 of the embodiment may have a configuration of being provided by being recorded on a computer readable recording medium such as a CD-ROM, a flexible disk (FD), a CD-R, a DVD (Digital Versatile Disc), or the like in a file of an installable format or an executable format.

In addition, a program that is executed by the POS terminal 11 and the code reading apparatus 101 of the embodiment may have a configuration of being provided by being stored on a computer that is connected to a network such as the Internet and being caused to be downloaded through the network. Further, a program that is executed by the POS terminal 11 and the code reading apparatus 101 of the embodiment may have a configuration of being provided or distributed through a network such as the Internet.

A program that is executed by the POS terminal 11 and the code reading apparatus 101 of the embodiment has a module configuration including each of the parts described above (the sales registration unit 611, the captured image recording unit 612, the captured image acquiring unit 1611, the barcode reading unit 1612, and the information output unit 1613), and as actual hardware, each of the above parts is loaded on a main memory apparatus by a CPU (processor) reading a program from the above ROM and executing the program, and the sales registration unit 611, the captured image recording unit 612, the captured image acquiring unit 1611, the barcode reading unit 1612, and the information output unit 1613 are generated on the main memory apparatus.

Further advantages and modifications of the invention may be derived readily by those skilled in the art. Accordingly, broader embodiments of the present invention are not limited by the details and the typical embodiments represented and described above. Thus, various modifications can be made without departing from the spirit or scope of the general concept of the present invention as defined in the appended claims and their equivalents.

What is claimed is:

1. A code reading apparatus comprising:
an image acquiring unit that acquires an image that is captured by an image capturing unit;
a code reading unit that detects a code symbol that is attached to a commodity which is contained in the acquired image and reads code information that corresponds to the code symbol;
an output unit that outputs the read code information;
a setting unit that performs setting of a operator; and
a recording unit that records the acquired image by associating the image with the operator information.

2. The apparatus according to claim 1,
wherein the image acquiring unit acquires a moving image that is captured by the image capturing unit and
the recording unit records the moving image that is acquired while the operator is being set by associating the moving image with the operator information.

3. The apparatus according to claim 1,
wherein the recording unit records an image that is related to reading of the code information by associating the acquired image with the output code information.

4. The apparatus according to claim 3,
wherein the recording unit records a frame image that is read from the code information by associating the frame image with the output code information.

5. The apparatus according to claim 3,
wherein the recording unit records an image of a predetermined period that spans a time point when the code information is read by associating the image with the output code information.

6. A sales registration apparatus comprising:
a code reading unit that detects a code symbol that is attached to a commodity which is contained in an image that is captured by an image capturing unit and reads code information that corresponds to the code symbol;
a setting unit that performs setting of a operator that registers sales of the commodity;
a sales registration unit that registers sales of the commodity based on the read code information; and
a recording unit that records the captured image by associating the image with the operator information.

7. The apparatus according to claim 6,
wherein the sales registration unit registers sales of the commodity by applying transaction identification information that is assigned to each transaction and
the recording unit records by including the applied transaction identification information.

8. The apparatus according to claim 6,
wherein the recording unit records an image that relates to reading of the code information by associating the image with the output code information.

9. The apparatus according to claim 8,
wherein the recording unit records a frame image that is read from the code information by associating the frame image with the output code information.

10. The apparatus according to claim 8,
wherein the recording unit records an image of a predetermined period that spans a time period when the code information is read by associating the image with the output code information.
